(19) United States
(12) Patent Application Publication
(10) Pub. No.: US 2018/0347715 A1
(43) Pub. Date: Dec. 6, 2018

(54) PRESSURE-BALANCING VALVE

(71) Applicant: Group Dekko, Inc., Garrett, IN (US)

(72) Inventor: Ricardo Schiesser, St. Joseph, MI (US)

(73) Assignee: Group Dekko, Inc., Garrett, IN (US)

(21) Appl. No.: 15/995,498

(22) Filed: Jun. 1, 2018

Related U.S. Application Data
(60) Provisional application No. 62/514,207, filed on Jun. 2, 2017.

(51) Int. Cl. F16K 11/24; F16K 11/044; F16K 39/02

(52) U.S. Cl. CPC F16K 11/24; F16K 17/085; F16K 39/022; F16K 11/044

(57) ABSTRACT

A valve assembly including a main body, a gate and an actuator. The main body defines a fluid chamber, with an inlet fluidly coupled to the fluid chamber, and an outlet also fluidly coupled to the fluid chamber. The gate has a first portion and a second portion connected to one another and both are subjected to a fluid pressure within the fluid chamber. The first portion is configured to close the outlet when the fluid chamber is pressurized due to a closing fluid force acting on the first portion. The second portion provides a counter-acting fluid force to the closing fluid force when the fluid chamber is pressurized. The actuator is coupled to the first portion or the second portion and is configured to provide a net opening force on the gate to open the outlet.

This is a non-provisional application based upon U.S. provisional patent application Ser. No. 62/514,207, entitled “PRESSURE-BALANCING VALVE”, filed Jun. 2, 2017, which is incorporated herein by reference.

### BACKGROUND OF THE INVENTION

### 1. Field of the Invention

The present invention relates to fluid controlling valves, and, more particularly to, valves that control the flow of fluids using pressure of the fluid to balance the force needed to open the valve.

### 2. Description of the Related Art

Numerous patents have issued dealing with problems associated with pilot operated valves, with a focus on how to reduce valve failures due to contaminants becoming lodged in the pilot and diaphragm apertures. Pilot valves operate on the principle of opening and closing an output pilot aperture that is part of a flexible diaphragm assembly, which in turn opens and closes the main fluid passage between the valve input and an output port. The valve input port is normally connected to the source of fluid, such as a pressurized water source. The valve output port is normally connected to a water consuming portion of an appliance, such as a clothes washing machine or dishwashing machine. An input pilot aperture allows fluid to enter a pilot chamber for the purpose of supplying fluid necessary to force the flexible diaphragm to a valve closed condition. This occurs when the output pilot aperture is closed to fluid flow by the de-energizing of a solenoid-controlled plunger. As with all pilot operated valves, the input pilot aperture (typically in the diaphragm) is always smaller in area than the output pilot aperture to allow a larger volume of fluid to escape through the output pilot aperture than can flow through the input pilot aperture. The blocking of the input pilot aperture(s) by contaminants can result in failure of the pilot valve to properly close, resulting in possible property damage. With this in mind, many design improvements have been patented to reduce the possibility of pilot aperture clogging by contaminants that may exist in the fluids that are being controlled by the pilot valve.

U.S. Pat. No. 3,593,957 issued to Dolter et al on Jul. 20, 1971 describes a pilot operated valve that utilizes small filter holes incorporated in the flexible diaphragm assembly to reduce the possibility of contaminants lodging in the input pilot aperture of the valve. This feature, or variations thereof, have been incorporated extensively in pilot valves that are in use today. Although it does offer an advantage over previous designs, experience has indicated that, because of the size of the filter holes and the limited number of holes provided, the contamination of the filter holes can lead to the failure of the pilot valve to close properly. One variation incorporates twelve holes molded into the rubber diaphragm, each hole being on the order of twenty-five thousandths of an inch in diameter. In such designs, when the pilot valve is in an open condition, allowing fluid to flow between its input and output ports, there will be continuous fluid flow through the filter holes and both the input and output pilot apertures. This continuous flow provides the opportunity for any fluid contaminants to clog the filter holes.

Richmond, in U.S. Pat. No. 5,269,333 issued Dec. 14, 1993 addresses the above problem by partially blocking fluid flow through the pilot apertures when the pilot valve is in an open condition, allowing fluid to flow from the input to the output ports. To accomplish this partial blocking of fluid flow through the input pilot aperture, an actuation chamber opening is molded into the diaphragm valve seat. When the diaphragm valve seat is pushed against the surface of the guide tube it substantially closes the pilot aperture to fluid flow. As described in the patent, the surface that the diaphragm valve seat encounters is slightly roughened to allow a micro-flow of fluid through the input pilot aperture. This micro-flow is necessary to allow the valve to change from an open condition to a closed condition when the solenoid is de-energized and the associated plunger closes the output pilot aperture.

There are two problems that become apparent when observing the design of Richmond. The first problem is the fact that a micro-flow is required, which allows continuous fluid flow through the pilot apertures when the pilot valve is open to fluid flow. Although the flow rate is small it still presents the opportunity for contaminants to clog the pilot apertures.

A difficulty with prior art technologies is their reliance on orifices or small apertures and their vulnerability to clogging with small contaminates.

What is needed in the art is a valve that has the advantage of small actuation forces, yet not being vulnerable to orifice clogging.

### SUMMARY OF THE INVENTION

The present invention is directed to a valve, and more particularly a fluid flow control valve using balanced pressure to reduce the energy required to open and close the valve.

The present invention provides a fluid control system having a housing and a connected valve assembly including a main body, a gate and an actuator. The main body defines a fluid chamber, with an inlet fluidly coupled to the fluid chamber, and an outlet also fluidly coupled to the fluid chamber. The gate has a first portion and a second portion connected to one another and both are subjected to a fluid pressure within the fluid chamber. The first portion is configured to close the outlet when the fluid chamber is pressurized due to a closing fluid force acting on the first portion. The second portion provides a counter-acting fluid force to the closing fluid force when the fluid chamber is pressurized. The actuator is coupled to the first portion or the second portion and is configured to provide a net opening force on the gate to open the outlet.

In another embodiment of the present invention there is provided a valve assembly including a main body defining a fluid chamber, a gate and an actuator. The gate has a first portion and a second portion connected to one another and both subjected to a fluid pressure within the fluid chamber. The main body has an inlet fluidly coupled to the fluid chamber and an outlet fluidly coupled to the fluid chamber. The gate controls fluid flow from the inlet to the outlet, the first portion being configured to maintain the gate in a closed position thereby preventing fluid flow from the inlet to the outlet when the fluid chamber is pressurized due to a closing fluid force acting on the first portion. The second portion providing a counter-acting fluid force to the closing fluid force when the fluid chamber is pressurized. The actuator is coupled to the first portion or second portion and is configured to provide a net opening force on the gate to open the outlet.

An advantage of the present invention is that the valve controls a large fluid flow with a reduced size actuator.

Another advantage of the present invention is that it avoids the problems with orifice clogging of pilot valves.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of a washing machine showing one embodiment of a water vacuum break with valves of the present invention;

FIG. 2 is a perspective view of the vacuum break assembly of FIG. 1 having an embodiment of solenoid valves of the present invention installed therein;

FIG. 3 is a cross sectional view of a prior art valve in the form of a pilot valve;

FIG. 4 is a cross sectional view of an embodiment of the valve of the present invention shown in the closed position;

FIG. 5 is a cross sectional view of the valve of FIG. 4 shown in the open position;

FIG. 6 is a cross sectional view of another embodiment of the valve of the present invention shown in the closed position;

FIG. 7 is a cross sectional view of yet another embodiment of the valve of the present invention shown in the closed position;

FIG. 8 is a perspective exploded view of a portion of the valve of FIG. 6;

FIG. 9 is a cross sectional view of the elements of FIG. 8 assembled together;

FIG. 10 is a perspective exploded view of the valve of FIG. 6;

FIG. 11A is a cross sectional view of an embodiment of a valve seating area of the valve of FIG. 6; and

FIG. 11B is a cross sectional view of another embodiment of a valve seating area of the valve of FIG. 6.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

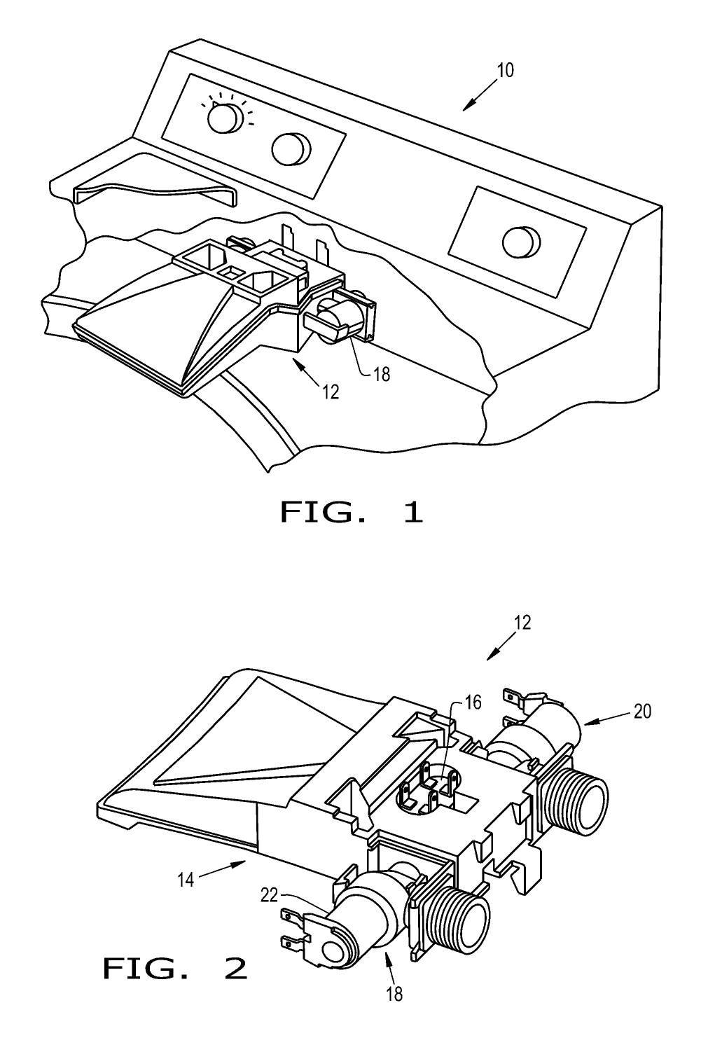

Referring now to the drawings, and more particularly to FIGS. 1 and 2, there is shown a water consuming appliance 10 in the form of a washing machine 10 including a fluid control system 12 in the form of a water vacuum break assembly 12 connected to washing machine 10. Vacuum break assembly 12 includes a housing 14, a temperature sensor 16, a valve assembly 18 and a valve assembly 20. Temperature sensor 16 is adjacent to a mixing cavity in which water from both the hot and cold supply are mixed and the temperature is controlled by a control device, not shown. Valve assemblies 18 and 20 are respectively assigned to cold and hot water supplies that are coupled in a conventional manner by way of a hose to hot and cold water supplies. Valve assemblies 18 and 20 are substantially similar and for all practical purposes are identical in every respect. For the sake of convenience only valve assembly 18 will be discussed, with the understanding that the attributes of valve assembly 18 are also included in valve assembly 20. Although a washing machine 10 is depicted the present invention may be utilized to control the flow of any fluid, whether or not it is included in a household appliance.

Valve assembly 18 includes a solenoid 22 for operative activation by a control system, not shown. Although solenoid 22 is depicted, it is understood that a control mechanism other than a solenoid may be utilized in operating valve assembly 18. Hot and cold water is mixed in a mixing chamber contained in vacuum break assembly 12, the chamber exists between valve assemblies 18 and 20. A control system variously activates valve assemblies 18 and 20 to control the temperature of water that travels through the mixing chamber of vacuum break 12.

Now, referring to FIG. 3 is shown details of a prior art valve assembly 118, which can be understood as being used in a prior art assembly 12 to control water in appliance 10. Valve assembly 118 includes a housing 120 with a fluid chamber 122, an inlet 124, an outlet 126, a diaphragm 128 with orifices 130, an actuator 132, an actuator chamber 134, and a pilot orifice 136. Here diaphragm 128 also serves as a seal keeping fluid from passing from inlet 124 to outlet 126. Pressure from the fluid in chamber 134 that has passed through orifices 130 and the spring of actuator 132 serve to keep fluid from flowing to outlet 126. When actuator 132 is activated then it retracts upward removing its seal of orifice 136. The size of orifice 136 is larger than the combined size of orifices 130. When the fluid in chamber 134 passes through orifice 136 there becomes a pressure differential on the two sides of diaphragm 128 causing diaphragm 128 to lift upward and unseal allowing the fluid to flow from inlet 124 to outlet 126. When actuator 132 is deactivated then diaphragm 128 is moved toward the sealing position and since orifice 136 is sealed the fluid that passes through orifices 130 equalizes the pressure on each side of diaphragm 128 so that the fluid pressure itself holds diaphragm 128 in the sealed position.

As mentioned earlier, valve assemblies 118, known as pilot valves, are vulnerable to clogging that can cause failure of the valve to open or close depending upon the extent of clogging of orifices 130 and/or 136. Another problem with pilot valves is that they are dependent upon fluid pressure to move the diaphragm, and if the fluid pressure is low the pilot valve will not function properly. The present invention will now be discussed to illustrate the inventive nature of still being able to use a small actuating force to control a pressurized valve, as with a pilot valve, but not having the vulnerabilities of the pilot valves that are widely used.

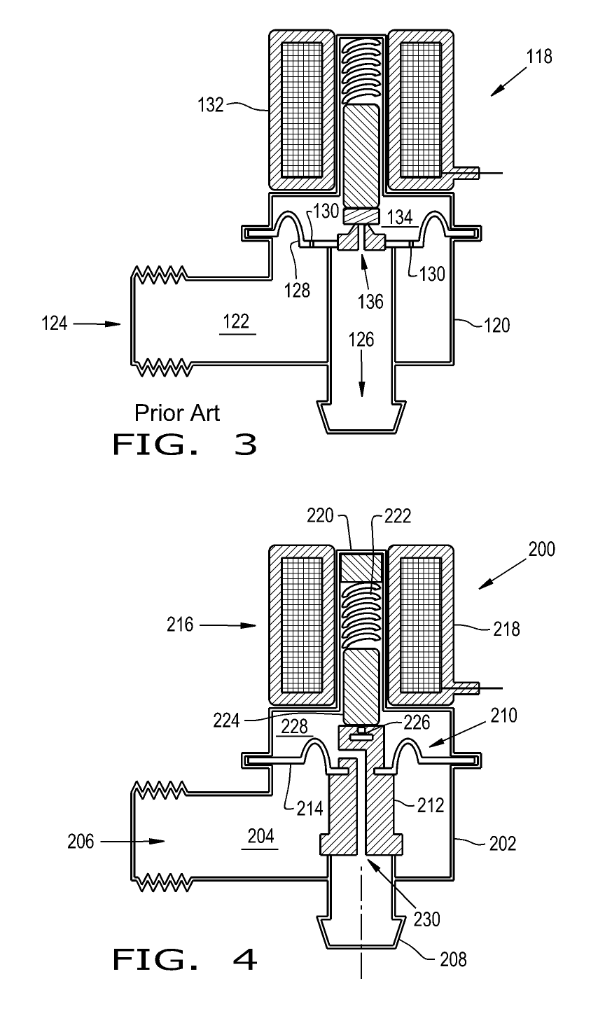

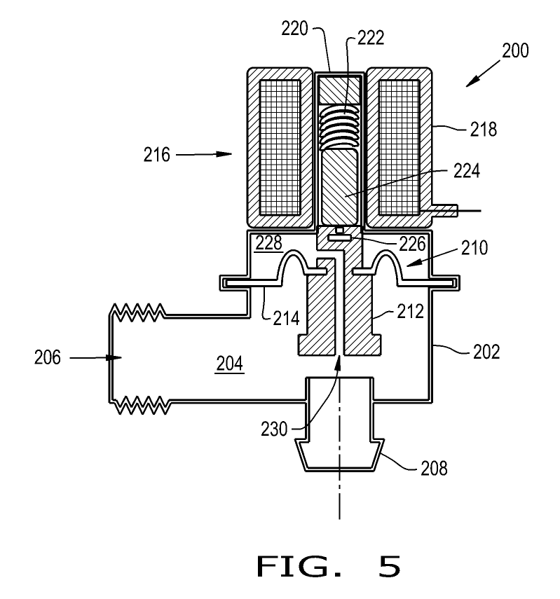

Now, additionally referring to FIG. 4 there is illustrated in a cross sectional view of an embodiment of a valve assembly 200 of the present invention. Valve assembly 200 includes a main body 202 defining a fluid chamber 204, an inlet 206 fluidly coupled to the fluid chamber 204, and an outlet 208 fluidly coupled to the fluid chamber 204. There is a gate 210 having a first portion 212 and a second portion 214 connected to one another and both subjected to a fluid pressure within the fluid chamber 204

First portion 212, is in the form of a sealing member 212 is configured to close the outlet 208 when the fluid chamber 204 is pressurized due to a closing fluid force (as in a downward directed pressure) acting on the first portion 212 holding sealing member 212 in a closed position. Second portion 214, in the form of a diaphragm 214, provides a counter-acting fluid force (as in an upward or opposite force) to the closing fluid force when the fluid chamber 204 is pressurized.

An actuator 216 is coupled to first portion 212 or second portion 214 of gate 210 and actuator 216 is configured to provide a net opening force on gate 210 to open outlet 208 allowing fluid flow from inlet 206/chamber 204. Actuator 216 can be in the form of a solenoid 216 having an electromagnetic coil 218 a thin walled housing 220, a biasing member 222, a plunger 224, and a coupling member 226. Electromagnetic coil 218 is coupled to a controller, not shown, and is activated as in the prior art. Housing 220 is coupled to main body 202 in a fluid tight manner. Biasing member 222 can be in the form of a spring located within housing 220. Plunger 224 has a magnetic property, being attracted to an electromagnetic field provided by coil 218 so as to move against spring 222 and to pull gate 210. Coupling member 226 is connected to a distal end of plunger 224 allowing a convenient coupling to gate 210 as detailed later.

The size of sealing member 212 and the size of diaphragm 214 are selected so that the counter-acting fluid force is optimized relative to the closing fluid force to thereby provide a balancing force to the closing fluid force. This optimized counter-acting force may be selected by defining the effective areas of members 212 and 214, such that the counter-acting force is less than the closing force, more than the closing force, or generally the same as the closing force, thus allowing other biasing elements to provide the controlling aspect of the valve. This allows for the opening and closing of valve 200 with a smaller activation force, supplied by actuator 216, than would be needed to overcome the closing fluid force. In the illustrated embodiment biasing member 222 is arranged to bias the gate 210 to a closed position with a biasing force. Actuator 216, when activated, overcomes the biasing force of spring 222 less any net opening force, which is supplied by the combination of the pressure against diaphragm 214 less the closing fluid pressure. When gate 210 is in an open position the closing fluid force and the counter-acting fluid force are reduced.

Diaphragm 214 is coupled to main body 202 and to gate 210 in a fluid tight manner, with no openings or orifices therein. Diaphragm 214 is illustrated as being symmetrical about a perpendicular axis established as the direction in which plunger 224 moves, although other configurations are also contemplated.

Actuator 216 includes an actuator chamber portion 228, with diaphragm 214 defining a part of the actuator chamber 228 boundary. Actuator chamber portion 228 is fluidly coupled to outlet 208 by way of a passageway 230 that allows actuator chamber portion 228 to be fluidly coupled to outlet 208. Passageway 230 is an opening that passes through gate 210, and more specifically through sealing member 212.

Plunger 224 is a moving member 224 within the actuator chamber portion 228 that is coupled to the gate 210. Moving member 224 is coupled to gate 210 by coupling member 226 in part of the passageway 230. This allows passageway 230 to serve both a coupling function but also allowing fluid flow therethrough to equalize pressure in actuator chamber 228 with outlet 208.

Now, additionally referring to FIG. 5, valve 200 is illustrated in an open position with gate 210 separated from outlet 208. Coil 218 is activated to overcome the bias of spring 222 with an upward force having been supplied by the fluid pressure against diaphragm 214 to help overcome the closing force of water pressure on gate 210. Once lifted the pressure differential across diaphragm 214 is lessened due to the presence of passageway 230, which is another advantage of the present invention, since the opening force is not then needed to overcome the closing force.

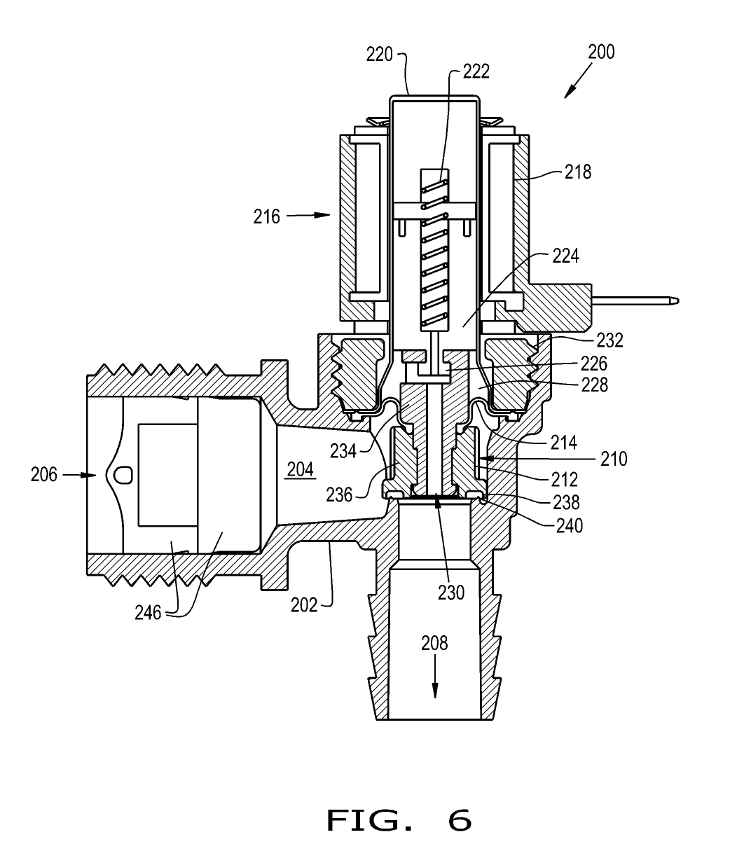

Now, additionally referring to FIG. 6, there is shown a more robust illustration of valve assembly 200. Housing 220 is coupled to main body 202 by a threaded member 232 that serves to also compress and seal diaphragm 214 to main body 202. Coupling member 226 is seen in passageway 230 as previously discussed. Additionally, details of gate 210 can be seen where sealing member 212 is shown coupled to diaphragm 214 by way of compression of a first part 234 and a second part 236. Second part 236 has an elastomeric seal 238 that interacts with a sealing profile 240 of outlet 208.

It should be appreciated that the terms “inlet” and “outlet” are used herein for convenience of description and not intended to be limiting, since fluid pressure in the fluid chamber will flow in a direction from high pressure to low pressure when the fluid chamber is pressurized and thus determine which port is the inlet and which port is the outlet. Inlet 206 can have a screen, such as a filter, associated therewith and be connected to a pressurized fluid source, such as a water feed line, to provide pressurized fluid within fluid chamber 204. In some embodiments, the inlet 206 can have threads formed on an outer surface of the inlet 206 for connecting to the pressurized fluid source. The outlet 208, on the other hand, can be fluidly coupled to a relatively low pressure destination so fluid can flow through fluid chamber 204 to the low pressure destination from the pressurized fluid line. In some embodiments, the outlet can be barbed to connect to a hose fluidly coupled to the low pressure destination. The valve assembly 200 described herein may be used, for example, in washing machines 10, dishwashers, oil and gas transmission lines, or any other application where selective pressurized fluid feed is used. It should therefore be appreciated that the valve assembly 200 described herein can be used in many different applications.

To selectively control fluid flow through outlet 208, valve assembly 200, gate 210 is formed with the first portion 212 and the second portion (here a diaphragm) 214 defined about a gate 210 centerline which usually is coaxial with an outlet 208 centerline, the first portion 212 having a first diameter about the gate centerline connected to the second portion 214 having a second diameter about the gate centerline which is less than the first diameter. The effective areas of the first portion and the second portion being established by the diameters. As can be seen, the first portion can be an enlarged diameter portion of the gate and the second portion 214 can be another enlarged diameter portion of the gate in the form of diaphragm 214 and connected to the first portion 212 by a rod, the second portion having a smaller diameter than the first portion. The relative effective areas of the first portion 212 and the second portion 214 can be configured so that either the closing force or the counter-acting force is larger to provide an inherent net force. It is also contemplated to closely balance the forces so that an active control selectively holds the valve in the desired position. When the first portion 212 has a larger effective area than the second portion 214 and is positioned adjacent to the outlet 208, the first portion 212 is configured to close the outlet when the fluid chamber is pressurized due to a closing force acting on the first portion 212 which is greater than a counter-acting fluid force acting on the second portion 214. In other words, the closing force acting on the first portion 212 due to the fluid pressure, biases the first portion 212 toward the outlet 208 to cover the outlet 208, with the opposing counter-acting force acting on the second portion 214 due to the fluid pressure, being less than the closing force. In this sense, the gate 210 is mechanically/fluidically “normally closed” when the fluid chamber 204 is pressurized. For certain applications, a spring 222 can provide the necessary closing force to bias the gate 210 into the closed position.

To open the gate 210, actuator 216 is coupled to gate 210 and is configured to provide a net opening force, which, when combined with the opposing counter-acting force caused by the fluid pressure, overcomes the closing force acting on the first portion 212 to move the first portion 212 away from the outlet 208 to thereby open outlet 208, allowing pressurized fluid to escape via outlet 208. The actuator may be, for example, a solenoid or other construction coupled to the second portion 214 via the enlarged diameter portion at an end of the second portion 214 which is diaphragm 214 or other sealing element. Once the actuator 216 is activated to provide the net opening force, the first portion 212 of the gate moves away from the outlet 208, allowing pressurized fluid in the fluid chamber to flow through the outlet and out the fluid chamber. Once the net opening force is removed by, for example, deactivating the actuator, the first portion can move back toward the outlet and seal the outlet, preventing further fluid flow through the outlet from the fluid chamber.

As can be seen, the diaphragm 214 can fluidly separate the fluid chamber from an additional chamber (chamber 228). A runoff channel 230 is formed which fluidly couples the additional chamber 228 to the outlet 208 so the fluid pressure formed “behind” the diaphragm 214 in the additional chamber 228 provides the counterbalancing fluid pressure on the first portion 212 opposed to the fluid pressure within the fluid chamber, reducing the amount of opening force which needs to be provided by the actuator 216 to open the gate 210. The runoff channel 230 can also pressurize the additional chamber 228 after the outlet opens to reduce the amount of net force needed to close the gate 210. Further, the runoff channel 230 can safely prevent fluid leakage out of the valve assembly in the event that the diaphragm 214 bursts or otherwise fails by fluidly coupling the additional chamber to the outlet. By counterbalancing the pressures in the additional chamber 228 and the fluid chamber 204, the magnitude of the opening force generated by the actuator 216 to produce the net opening force can be reduced so actuators 216 of relatively small size can be used to open the gate and uncover the outlet while being less prone to failure from contamination.

From the foregoing, it should be appreciated that the previously described valve assembly 200 benefits from having both the first portion 212 and the second portion 214 subjected to the same fluid pressure within the fluid chamber, combined with assistance from the use of the runoff channel or otherwise. Such a configuration can minimize the effect that fluid pressure variations have on the operation of valve assembly 200. The fluid pressure variations may be, for example, due to differences in local service water pressures in water utility lines. Further, since the openings in the valve assembly, as in passageway 230, can be dimensioned to be relatively large, as opposed to typical pilot valves which have small apertures, the previously described valve assembly 200 is less prone to failure caused by particles entrapped in the pressurized fluid than typical pilot valves. Even further, balancing the fluid forces as previously described reduces the effect of high fluid pressure on the net opening force the actuator must provide to open the outlet, which allows for reasonably sized actuators to be used even when the fluid pressure in the fluid chamber is relatively high.

Referring now to FIG. 7, an alternative embodiment of a valve assembly 300 formed according to the present invention is shown (with similar elements having the same numbers of the previous embodiment, but increased by 100) which includes a fluid chamber 304 with an inlet 306, an outlet 308, and a gate 310 including a first portion 312 and a second portion 314 subjected to a fluid pressure within fluid chamber 304. As can be seen, first portion 312 and second portion 314 are pivotally connected to one another at a pivot 350 defining a pivot axis so the gate has a “see-saw” action. First portion 312 can define a first pivot length L1 between a first end of the first portion and a second end of the first portion and the second portion 314 can define a second pivot length L2 between a first end of the second portion and a second end of the second portion, the second pivot length can be different than the first pivot length so the fluid force acting on the first portion and second portion due to the fluid pressure can be the same or tend to bias the “see-saw” toward either end. As can be seen in FIG. 7, the first portion 312 of the gate and the second portion 314 of the gate are both placed within the fluid chamber 304 so the gate 310 can be biased by the spring with the balance of the fluid forces being biased or neutral. In this embodiment first portion 312 and second portion 314 are not in-line, but are angled relative to one another. Such an arrangement allows an actuator 316 connected to the second portion 314 to produce a net opening force extending in a direction which is generally parallel to a first portion 312 axis of the first portion 312 in order to open the outlet 308, and may be useful to meet space requirements in certain applications. The valve assembly 300 has an additional fluid chamber 328 on a side of diaphragm 314 opposite the fluid chamber 304, with the additional fluid chamber 328 being fluidly coupled to the outlet 308 by a runoff channel 330, similarly to the previously described valve assembly.

In any of the previously described embodiments, certain measures can be included to reduce the risk of valve assembly malfunction. For example, in some embodiments the valve assembly may incorporate a “cage” assembly around the first portion of the gate in the event that the first portion and the second portion separate from one another in a manner that might uncontrollably leave the outlet opened, with the cage assembly keeping the first portion of the gate in an area adjacent the outlet and oriented so the vacuum formed at the outlet can pull the first portion to the outlet and close the outlet. In other embodiments, the valve assembly can incorporate motion limiting stops at, for example, the first portion and second portion of the gate to prevent excessive movement of either portion during operation. In other embodiments, the valve assembly can incorporate motion guides at any of the moving parts, including but not limited to the portions of the gate and the actuator, to direct motion in a desired manner to promote desired operation and/or reduce the risk of wear and breakage of any of the moving parts. The foregoing measures are exemplary only, and other measures are contemplated as being included in valve assemblies formed according to the present invention.

From the foregoing, it should be appreciated that exemplary embodiments of the present invention can take advantage of counter-balancing forces provided by fluid pressure, either directly or indirectly, acting on the previously described first portions and second portions of gates to reduce the effect that varying fluid pressures have on the opening force required to open an outlet. The counter-balancing forces can act on a gate with the first portion and the second portion connected directly in-line with one another, or a gate with the first portion and the second portion pivotally connected to one another in a “see-saw” arrangement. In either arrangement, the relative diameters, lengths, thicknesses, etc. of the first portion and second portion can be adjusted to produce desired respective forces from the fluid pressure acting on the first portion and second portion, with the fluid pressure forces acting on the first portion, which can close the outlet, being countered by the fluid pressure forces acting on the second portion, so an actuator can exert a relatively small net opening force on the second portion to open the outlet from the normally closed position of the first portion.

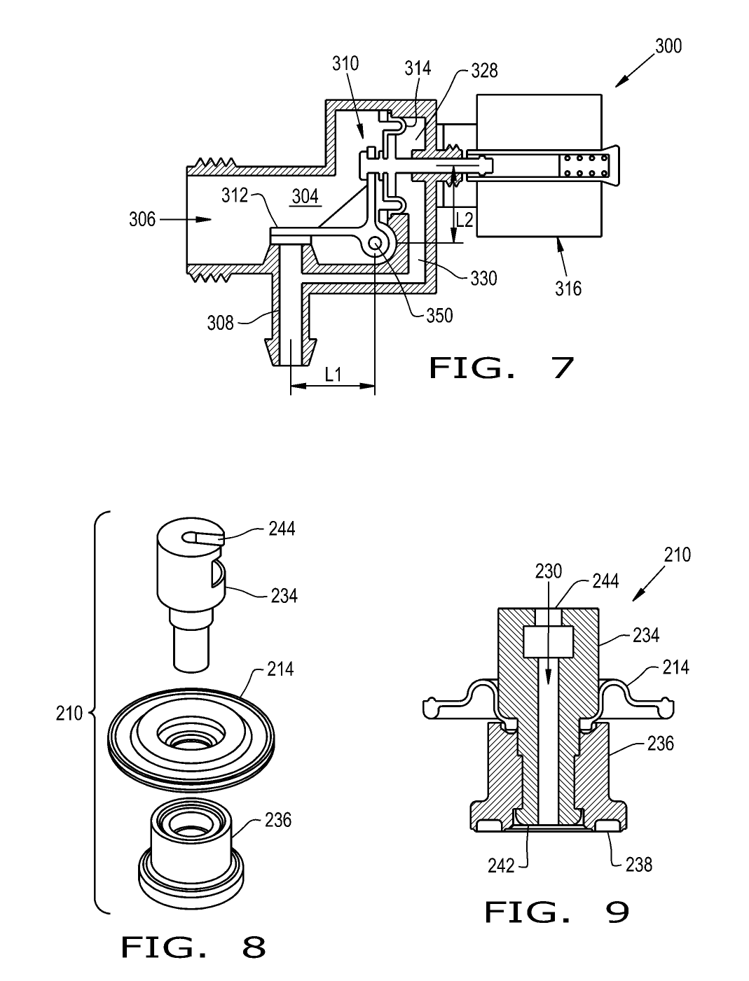

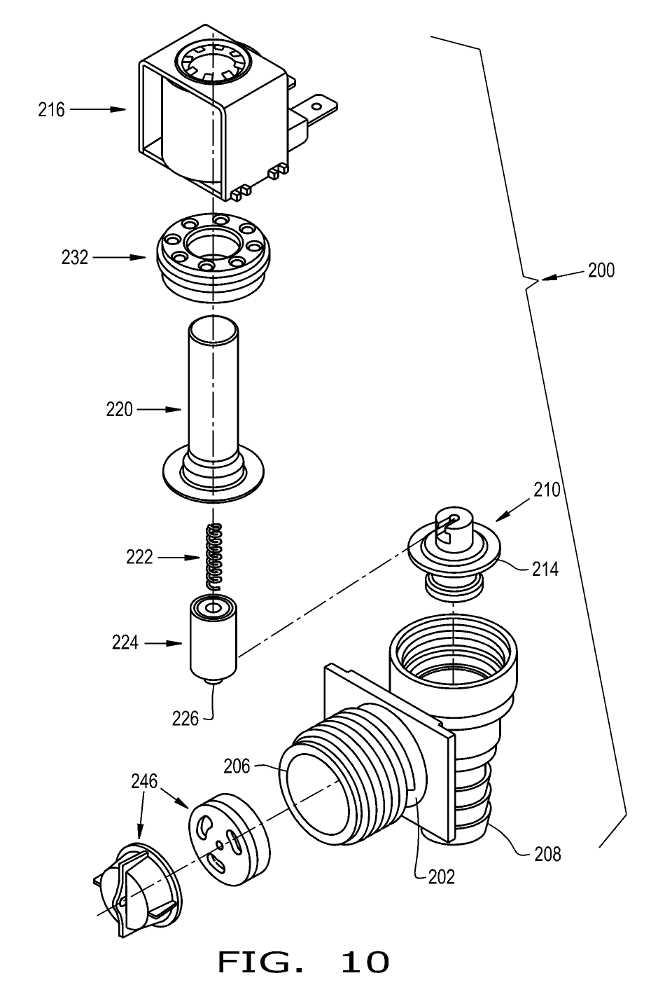

Now, additionally referring to FIGS. 8 and 9, there is illustrated three parts of gate 210 and how they are assembled. First part 234 is inserted through an opening in diaphragm 214 and inserted through second part 236. While first part 234 is pressed toward second part 236 a shaped heated tool is used to form end 242 as shown in FIG. 9, changing a cylindrical shape to that shown to thereby form gate 210 as an integrated assembly. A notch 244 in first part 234 is used so that coupling member 226 can slide into part 234.

Now, additionally referring to FIG. 10, there is shown an exploded perspective view of valve 200, which here additionally has a screen and flow regulator assembly 246 insertable into inlet 206. Threaded member 232 is separate from thin wall metal housing 220 allowing the assembly to thereby eliminate scrubbing that would otherwise occur between the face of diaphragm 214 and member 232. Additionally, the thin wall housing 220 improves the efficiency of solenoid 216.

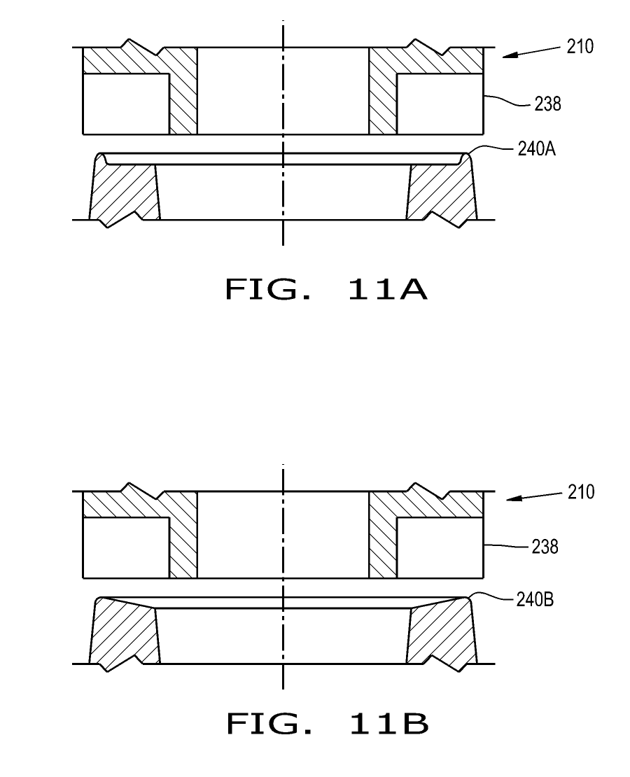

Now, additionally referring to FIGS. 11A and 11B there are illustrated two versions of sealing profiles 240, here referred to as 240A and 240B. Sealing profiles 240A and 240B provide a distinct diameter for seal 238 to contact as gate 210 closes. Seal 238 can be made from EPDM or some other flexible resilient material. Seal profile 240 and flat seal 238 provide for initial contact at exactly the desired diameter, to ensure consistency of the force and provides a large enough contact area to protect the seal material from exceeding its maximum recommended stress or specific pressure.

While the present invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fluid control system, comprising:
a housing; and
at least one valve assembly coupled to the housing, the valve assembly including:
a main body defining a fluid chamber, an inlet fluidly coupled to the fluid chamber, and an outlet fluidly coupled to the fluid chamber;
a gate having a first portion and a second portion connected to one another and both subjected to a fluid pressure within the fluid chamber, the first portion being configured to close the outlet when the fluid chamber is pressurized due to a closing fluid force acting on the first portion, the second portion providing a counter-acting fluid force to the closing fluid force when the fluid chamber is pressurized; and
an actuator coupled to the first portion or second portion and configured to provide a net opening force on the gate to open the outlet.

2. The fluid control system of claim 1, wherein the counter-acting fluid force is less than the closing fluid force and provides a balancing force to the closing fluid force.

3. The fluid control system of claim 1, the valve assembly further comprises a biasing member arranged to bias the gate to a closed position with a biasing force.

4. The fluid control system of claim 3, wherein the actuator when activated overcomes the biasing force less the net opening force.

5. The fluid control system of claim 3, wherein the closing fluid force and the counter-acting fluid force are reduced when the gate is in an open position.

6. The fluid control system of claim 1, wherein the second portion includes a fluid tight diaphragm coupled to the main body and to the gate.

7. The fluid control system of claim 6, wherein the actuator includes an actuator chamber portion, the diaphragm defining a part of the actuator chamber portion boundary.

8. The fluid control system of claim 7, wherein the actuator chamber portion is fluidly coupled to the outlet.

9. The fluid control system of claim 8, wherein the gate has a passageway that allows the actuator chamber portion to be fluidly coupled to the outlet.

10. The fluid control system of claim 9, wherein the actuator includes a moving member within the actuator chamber portion that is coupled to the gate.

11. The fluid control system of claim 10, wherein the moving member is coupled to the gate in part of the passageway.

12. The fluid control system of claim 6, wherein the diaphragm provides at least part of the counter-acting force to the gate and the diaphragm has no orifice therethrough.

13. A valve assembly, comprising:
a main body defining a fluid chamber;
a gate having a first portion and a second portion connected to one another and both subjected to a fluid pressure within the fluid chamber, the main body having an inlet fluidly coupled to the fluid chamber and an outlet fluidly coupled to the fluid chamber, the gate controlling fluid flow from the inlet to the outlet, the first portion being configured to maintain the gate in a closed position thereby preventing fluid flow from the inlet to the outlet when the fluid chamber is pressurized due to a closing fluid force acting on the first portion, the second portion providing a counter-acting fluid force to the closing fluid force when the fluid chamber is pressurized; and
an actuator coupled to the first portion or second portion and configured to provide a net opening force on the gate to open the outlet.

14. The valve assembly of claim 13, wherein the counter-acting fluid force is less than the closing fluid force and provides a balancing force to the closing fluid force.

15. The valve assembly of claim 13, wherein the second portion includes a fluid tight diaphragm coupled to the main body and to the gate.

16. The valve assembly of claim 15, wherein the actuator includes an actuator chamber portion, the diaphragm defining a part of the actuator chamber portion.

17. The valve assembly of claim 16, wherein the actuator chamber portion is fluidly coupled to the outlet.

18. The valve assembly of claim 17, wherein the gate includes a passageway that allows the actuator chamber portion to be fluidly coupled to the outlet.

19. The valve assembly of claim 18, wherein the actuator includes a moving member within the actuator chamber portion that is coupled to the gate.

20. The valve assembly of claim 17, wherein the main body includes a passageway that allows the actuator chamber portion to be fluidly coupled to the outlet.
